(19) United States
(12) Patent Application Publication
(10) Pub. No.: US 2013/0030914 A1
(43) Pub. Date: Jan. 31, 2013

(54) SERVER CONFIGURATION TO FACILITATE SYSTEM AND METHOD FOR TARGETED ADVERTISING

(71) Applicant: James C. Ho, Redondo Beach, CA (US)

(72) Inventor: James C. Ho, Redondo Beach, CA (US)

(73) Assignee: Zadspace, Norwalk, CT (US)

(21) Appl. No.: 13/586,299

(22) Filed: Aug. 15, 2012

Related U.S. Application Data
(63) Continuation-in-part of application No. 13/425,902, filed on Mar. 21, 2012.
Application No. 13/425,902 is a continuation-in-part of application No. 13/183,277, filed on Jul. 14, 2011.
Application No. 13/183,277 is a continuation-in-part of application No. 11/461,622, filed on Aug. 1, 2006.
Application No. 11/461,622 is a continuation-in-part of application No. 11/423,692, filed on Jun. 12, 2006.

(51) Int. Cl. G06Q 30/02

(52) U.S. Cl. 705/14.53; 705/14.49; 705/14.58; 705/14.66

(57) ABSTRACT

A parcel advertising system and method for providing a targeted advertisement on a package wherein the advertisement is specifically directed towards a recipient to whom to the package is being delivered. The system includes an image server located remotely from a warehouse management system and adapted to communicate with the warehouse management system via a communications network. The image server includes a computer system including at least one processor and at least one datastore, wherein the computer system is operative and configured to select an advertisement for a package in response to an advertisement request for a parcel from a warehouse management system.

### CLAIM OF PRIORITY

This application is a Continuation-In-Part of U.S. Ser. No. 13/425,902, filed on Mar. 21, 2012, which claims priority to U.S. application Ser. No. 13/183,277, filed on Jul. 14, 2011, which claims priority to U.S. application Ser. No. 11/461,622, filed on Aug. 1, 2006, which claims priority to U.S. application Ser. No. 11/423,692, filed on Jun. 12, 2006. These disclosures are hereby incorporated by reference herein in their entireties.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This application generally relates to the field of printing targeted advertising, and in particular, to printing targeted advertisements on parcel packages using a remotely located image advertisement server.

### BACKGROUND OF THE INVENTION

Advertisers place promotions or other advertisement in locations where they are viewed (and hopefully absorbed) by other persons or entities. These locations can be both physical and/or virtual (i.e., off-line and/or on-line). For example, such locations include television, newspapers, magazines, and the Internet. These advertisements or promotions can be directed regionally, according to cities, counties, states, or countries in which they are placed.

Additionally, a wide variety of different mediums may be utilized for advertising. Advertisers choose specific mediums and locations for the placement of their advertisements in order to attempt to expose the advertisement to an intended audience. For example, a marketer of female cosmetics may choose to build awareness for a new line of female cosmetics by placing an advertisement in a magazine that has a large readership of females.

Various methods of advertising and/or promoting have associated advantages and drawbacks. Thus, advertisers are often inclined to pay professional advertising organizations, entities, and individuals to target and dispense their advertisements, as they seek more effective mediums, locations, and techniques for targeting, placing, and measuring the effectiveness of promotions. The advertisements and/or promotions that are suggested or used by these entities typically include expensive media or printed materials that have high distribution costs associated with them. Even Internet-based promotions, which tend to be quite efficient, still have high costs associated with them, since popular web sites often charge a premium on a per-impression basis for placing banners or links on their web pages. Further, while Internet use has increased, it is desirable to provide a form of promotional advertisement that is more readily viewed by the consuming public without having to log on to a computer.

The assignee of the present application described in previous applications, methods and systems for providing targeted advertisement on a package to be delivered to a recipient. Advertisement information is received from an advertiser that includes one or more advertisements that the advertiser desires to be placed. An advertisement for the package is either selected or created in response to analyzing the advertisement, package characteristics, and recipient characteristics. The advertisement is then placed on the package for delivery. Accordingly, the present application provides for further improvements to the methods and systems for providing targeted advertisements on packages including more efficient processes for a large warehouse setting and automation of the advertisements placed on the packages for delivery.

### SUMMARY OF THE INVENTION

The invention relates to a method and system for determining a targeted advertisement for a package, wherein the advertisement is preferably directed towards a recipient to whom to the package is being delivered. The invention includes receiving advertisement information including one or more advertisements that are desired to be placed. The advertisement information is associated with advertisement selection criteria. A request for a package to be delivered to the recipient is received wherein the package preferably has one or more package characteristics. And the recipient preferably has one or more recipient characteristics including at least one location characteristic. The advertisement selection criteria associated with an advertisement is analyzed in conjunction with analyzing the package characteristics and recipient characteristics associated with the package and its recipient. An advertisement is selected for the package in response to the analyzing of the advertisement selection criteria, package characteristics, and recipient characteristics such that the selected advertisement is placed on the package for delivery.

In one aspect a parcel advertising system and method is described for providing a targeted advertisement on a package wherein the advertisement is preferably directed towards a recipient to whom to the package is being delivered. The system includes an image server located remotely from a warehouse management system and adapted to communicate with the warehouse management system via a communications network. The image server includes a computer system including at least one processor and at least one datastore, wherein the computer system is operative and configured to select an advertisement for a package in response to an advertisement request for a parcel from a warehouse management system.

### BRIEF DESCRIPTION OF THE DRAWINGS

The invention(s) is/are illustrated in the figures of the accompanying drawings which are meant to be exemplary and not limiting, in which like references are intended to refer to like or corresponding parts, and in which:

FIG. 1 illustrates an exemplary computer system which may be used with certain components of illustrated embodiments of the invention;

FIG. 2 illustrates a component diagram of a system for providing targeted advertising on parcel packages according to one embodiment;

FIGS. 3 and 4 illustrate flowcharts depicting methods for obtaining a promotion for a parcel according to certain illustrated embodiments; and

FIGS. 5 and 6 illustrate system level flow diagrams for methods for obtaining a promotion for a parcel according other illustrated embodiments.

### DETAILED DESCRIPTION OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “the signal” includes reference to one or more signals and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

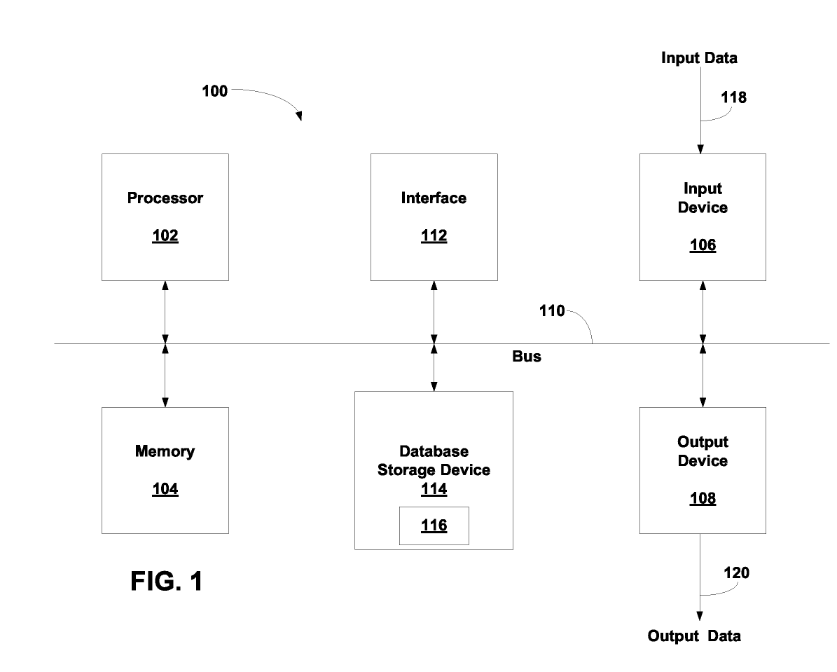

Turning now descriptively to the drawings, in which similar reference characters denote similar elements throughout the several views, FIG. 1 depicts an exemplary general-purpose computing system in which illustrated embodiments of the present invention may be implemented.

A generalized computering embodiment in which the present invention can be realized is depicted in FIG. 1 illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, tablet devices, smart phone devices, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

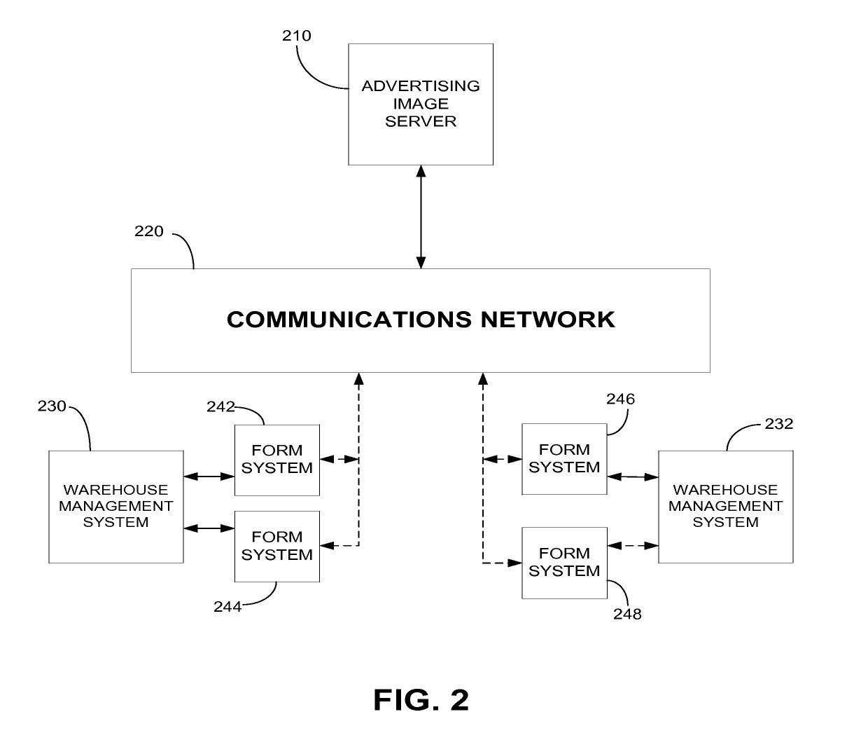

With the exemplary computing system environment 100 of FIG. 1 being generally shown and discussed above, an illustrative embodiment of a parcel targeted-advertising system, constructed in accordance with the invention is shown in FIG. 2, designated generally by reference numeral 200, which is to be understood to incorporate system 100, or components thereof. Advertising system 200 enables an advertisement or other displayable materials to be selected, targeted, and dispensed preferably onto an outer surface of a parcel or package. In this manner, advertisers can effectively target appropriate advertisements to the recipients of ordered parcels/packages using available space on the parcel's outer surface, which may include a portion of a postage label. The advertisements and/or promotions are created, selected, or otherwise determined using parameters that have been provided by, or deduced from, the recipients of ordered parcels/packages, including by way of example only, and not by way of limitation, characteristics deducible from order product and the location of the recipient (e.g., zip code).

Advertising system 200 is to be understood to include several components for enabling the selecting, targeting, and dispensing of advertising labels on their associated parcels. For instance, each of the components are described in U.S. application Ser. Nos. 13/425,902; 13/183,277; 11/461,622; and 11/423,692, each of which is incorporated herein by reference in its entirety. The illustrated embodiment of the advertising system 200 shown in FIG. 2 includes an advertising image server 210 100 coupled to a communications network 220 which is preferably coupled to a plurality of warehouse management systems 230, 232, etc. It is to be understood numerous warehouse management systems may be employed in advertising system 200 with each warehouse management system being associated with a single parcel shipper. The functionality of the warehouse management system will be described further below. It is further to be understood a single parcel shipper may use multiple geographical disposed warehouse management systems. For ease of description purposes, reference will be made below to only a single warehouse management system 230, which the present invention is not to be understood to be limited thereto. Warehouse management system 230 is to be understood to be located geographically remote from advertising image server 210 (e.g., in another, building, city, state, country or continent) and couples to the advertising image server 210 via communications network 220 (e.g., the Internet). It is to be understood and appreciated that while warehouse management system 230 is shown (in the illustrated embodiment of FIG. 2) located in a common geographic location as form management systems 242-244 (as described below), warehouse management system 230 is not to be understood to be limited thereto as it may be remotely located from form management systems 242-244 (e.g., located in the Internet “cloud”) preferably using communications network 220 to connect to both the advertising image server 210 and the form management systems 242-244.

Each warehouse management system 230 is coupled to one or more form management systems 242-248 functional to print and/or apply advertising labels to a parcel, the functionality of which will be described further below. As illustrated in FIG. 2, each form management system may be coupled directly to a warehouse management system 230 (e.g., located in a common geographic location) or remotely to a warehouse management system 230 via communications network 220 (located in a remote geographic location).

In accordance with the illustrated embodiment of FIG. 2, an advertiser uses system 200 to create and transmit information about their advertisements and/or promotions to advertiser image server 210, preferably via the communications network 220. Additionally, package handlers use their computer systems (e.g., warehouse management system 230) to request advertisements and/or promotions from advertiser image server 210 (preferably, via the communications network 220) for placement on a parcel/package. It is to be appreciated and understood that while the illustrated embodiment shows only a single advertising image server 210, other embodiments may employ multiple separate advertising image servers, each having different and/or redundant functionality.

The advertiser image server 210 then creates, selects, or otherwise determines the appropriate targeted advertisements and/or promotions using parameters that have been provided by, or deduced from, the recipient information relating to the ordered parcel/package. Continuing, in this embodiment, advertiser image server 210 of system 200 responds to package handler requests and transmit information about the advertisements and/or promotions to be placed on the package preferably to its warehouse management system 230. In one such embodiment, the package handler then outputs the targeted advertisements into a form management system 242 so as to be placed onto a label which is then placed on the associated parcel/package.

As stated above, in parcel advertising system 200, appropriate targeted advertisements and/or promotions utilize parameters that have been provided by, or deduced from, the recipient information relating to the ordered parcel/package. For example, and not by way of limitation, targeting specific criteria include: information regarding who purchased a specific item within a specific time frame; information regarding who lives at a specific address; information regarding who works at a specific company; information regarding who belongs to a specific organization; or information regarding past purchases.

In one aspect of a preferred embodiment, the parcel targeted-advertising system 200 utilizes a communication network 220 to transmit and receive information. The communication network 220 transmits information between components of the system 200. In one embodiment, the parcel targeted-advertising system 200 utilizes any combination of analog and/or digital communication protocols. For example, and not by way of limitation, communication mediums include: analog and/or digital telephony lines, wired and/or wireless networks, computer networks of any kind (including the Internet), and/or cellular (or other mobile telephone spectrum) networks.

In one aspect of the illustrative embodiment, advertisers use the advertiser systems 200 to create, transmit, and access information about advertisements and/or promotions they wish to sponsor. Using advertiser system 200, the advertiser defines the nature, contents, and characteristics of the advertisements (“advertisement information”), which is then transmitted as advertisement data to the advertiser image server 210, which stores the promotion data in memory. The advertiser image server 210 is preferably configured and operative to analyze the advertisement information stored to determine selection criteria associated with the advertisement. The analysis produces an inventory of advertisements (“advertisement inventory”), along with advertisement information for each advertisement. In some embodiments of the advertising system 200, other components (i.e., core systems analytics and core systems advertisement and/or promotional placements) may also be utilized during this process.

In another aspect of the illustrative embodiment, package handlers request advertisements (and/or promotions) for placement on a package. In one preferred embodiment of the advertising system 200, package handler systems include warehouse management systems 230 and one or more form management systems 242. The form management systems 242 preferably transmit information about the nature, contents, and characteristics of a package (“package information”) to the image server 210. In another aspect of a preferred embodiment, one or more form management systems 242 are then used to place the selected (or created) advertisements on their associated package.

The advertiser image server 210 is preferably configured and operative to receive, analyze, and return advertising and/or promotional requests. As mentioned above, in one embodiment, the most suitable advertisements for a given package are identified using system analytics and system advertising and/or promotional placements as well as (optionally) third party processors and third party databases. Due to the benefit in targeted advertising, advertisers and other third parties have begun or increased their collection and analysis of market information (e.g., sales data, census data, demographics, and retail purchases) to assist in targeted advertising campaigns to individuals or groups. Through various quantitative and qualitative techniques (e.g., data mining, predictive and trend analysis, consumer behavioral modeling, consumer interviews), these advertisers can develop models and profiles that assist in the development, placement, and content of an advertisement.

Thus, advertiser targeting server 210 preferably uses the parameters issued by the warehouse management systems 230 of the package handler systems to identify (or create) a set of eligible advertisements and/or promotions. In another aspect of a preferred embodiment, advertiser targeting server 210 is configured and operative to further refine the results until a set of advertisements and/or promotions customized to the nature, contents, and characteristics of the advertisement and/or promotional request is identified (from a list or matrix) or created (using advertisement generation formulas or rules). The warehouse management system 230 receives the customized advertisement and/or promotion (via communications network 220) preferably as a reply to the previously issued advertisement and/or promotional request. As described above, the advertisement set is then generated by the form management system 242 so as to be applied to the package utilizing an appropriate medium.

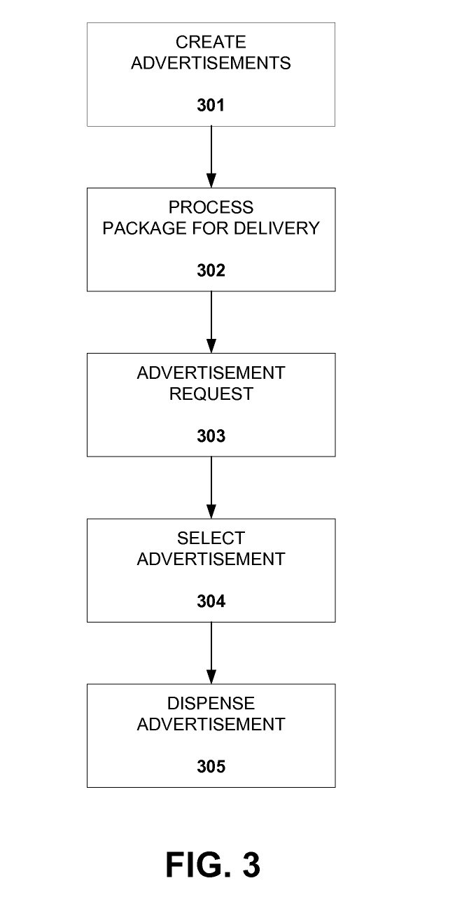

With the generalized system components of the advertising system 200 described above, discussion will now turn to its generalized operation. Referring now to FIG. 3, a process flow diagram is illustrated of one preferred embodiment of a parcel targeted-advertising method. First, promotions (advertisements, or components thereof) are created by an advertiser (step 301). Next (step 302), warehouse management system 230 package begins to process a package to be delivered. At step 303, requested advertisements and/or promotions to be placed on a parcel are preferably made from a warehouse management system 230 to the remotely located advertising image server 210. Preferably, the warehouse management system 230 transmits unique parcel attributes (e.g., name, address, parcel contents, etc.) to the advertising image server 210 to facilitate the selection of targeted advertisements. Thus, at step 304, promotions (and/or advertisements) are preferably selected in the advertising targeting server 210 by analyzing the nature, contents, and characteristics of the package and the available advertisements/promotions so as to assign certain advertisements/promotions to certain parcels/packages. The selected promotions are then sent from the advertising image server 210 to preferably a remotely located warehouse management system 230 (via communications network 220). It is to be understood a plurality of uniquely targeted promotions are preferably transmitted. In another preferred embodiment, the advertisements and/or promotions are created in advertising targeting image server 210 from advertisement and/or promotions subcomponents used by analyzing the nature, contents, and characteristics of the package and available advertisements and/or promotions. Finally, the selected advertisements and/or promotions (as generated by the image server 210) are dispensed and placed on the package (step 705). In essence, a warehouse management system 230, in conjunction with a form management system 242, merges targeted advertisements/promotions (as generated by the image server 210) with shipping documents, or other ancillary printed matter, to be affixed to a parcel.

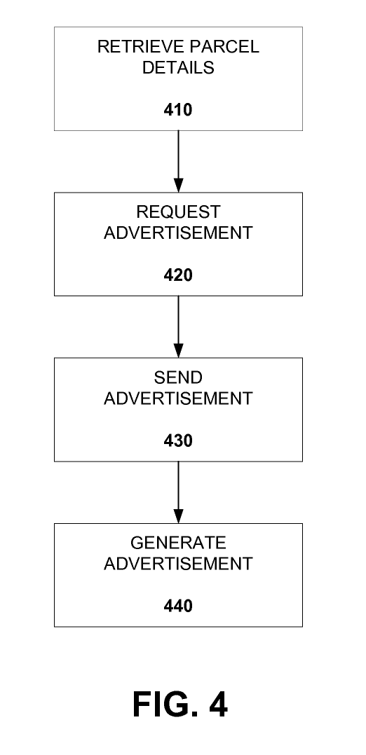

With reference now to FIG. 4 (in conjunction with continuing reference to FIG. 2) another method of operation of an illustrated embodiment is described. Starting at step 410, during a package handling process, a form management system 242 preferably requests details for a parcel to be delivered. Using the requested, and retrieved, parcel details, the form management system 242 requests from the advertising image server 210 advertising information to be used for the parcel (step 420). Upon determination and retrieval, the advertising image server 210 sends the requested advertising information to the form management system 242 (step 430). The requested advertisements and/or promotions (as generated by the image server 210) are dispensed and placed on the parcel preferably via the form management system 242 (step 440).

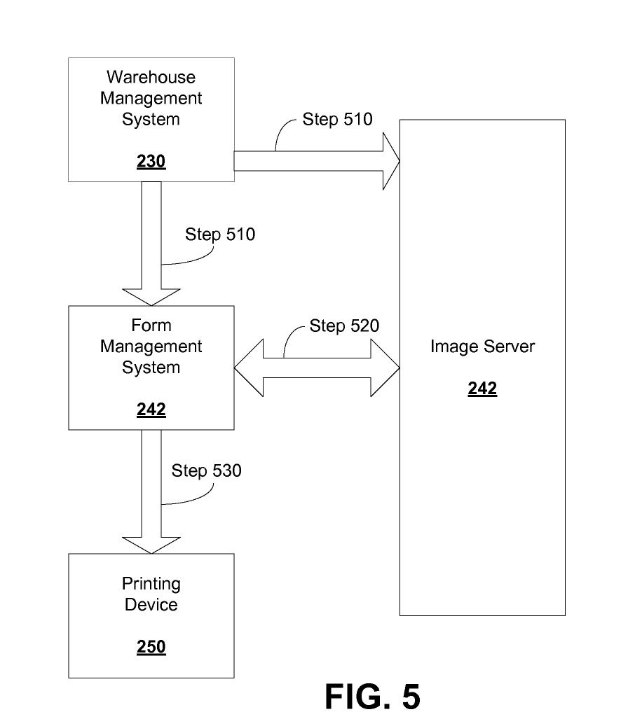

With reference now to FIG. 5, operation of another illustrated embodiment is described for a package handling process. Starting at step 510, a warehouse management system 230 provides package details for a parcel to be delivered to both a form management system 242 and an advertising image server 210. Afterwards, the advertising image server 210 corresponds with the form management system 242 so as to preferably format an advertisement (whether to be applied to an addressing label or not) to be affixed to a parcel (step 520). Next, the form management system 242 provides the aforesaid data regarding the formatted advertisement to a printer device 250 so as to be printed upon a label for affixation upon a parcel or to be printed directly upon the parcel (step 530).

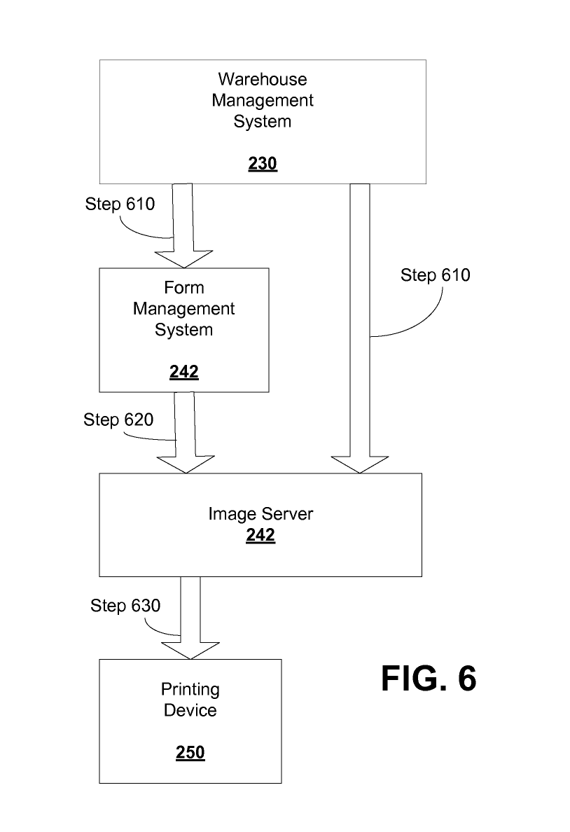

With reference now to FIG. 6, operation of yet another illustrated embodiment is described for a package handling process. Starting at step 610, a warehouse management system 230 provides package details for a parcel to be delivered to both a form management system 242 and an advertising image server 210. The form management system formats a label and/or indicia to be applied to a parcel and sends this data to an advertising image server 210 (step 620), Next, the advertisement image server 210 integrates selected advertising information with the aforesaid data received from the form management system 242 and formats it for application by a printing device 250 which is thereafter applied upon a label for affixation to a parcel or to be printed directly upon the parcel (step 630).

Therefore, a particular advantage of the above described illustrative embodiment is it enables a parcel advertiser to use a remotely located advertising image server to communicate with remotely located warehouse management systems (preferably using off-the-shelf form management software) to generate and print an integrated form which may, or may not, include an advertisement/promotion.

The above presents a description of a best mode contemplated for carrying out the present invention, and of the manner and process of making and using it, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A parcel advertising system for providing a targeted advertisement on a package wherein the advertisement is specifically directed towards a recipient to whom to the package is being delivered, the system comprising an image server located remotely from a warehouse management system and adapted to communicate with the warehouse management system via a communications network, the image server including a computer system including at least one processor and at least one datastore, wherein the computer system is operative and configured to select an advertisement for a package in response to an advertisement request for a parcel from a said warehouse management system.

2. A parcel advertising system as recited in claim 1 wherein the image server is coupled to and located remotely from a plurality of warehouse management systems.

3. A parcel advertising system as recited in claim 1 wherein the warehouse management system is coupled to a form management system operative and configured to generate a label having at least said selected advertisement.

4. A parcel advertising system as recited in claim 1 wherein the warehouse management system is coupled to a plurality of form management systems each operative and configured to generate a label having at least said selected advertisement.

5. A parcel advertising system as recited in claim 2 wherein each of the plurality of warehouse management systems is coupled to at least a respective form management system operative and configured to generate a label having at least said selected advertisement.

6. A parcel advertising system as recited in claim 1 wherein the computer system of the image server is further configured and operative to receive advertisement information including one or more advertisements that are desired to be placed, wherein the advertisement information is associated with advertisement selection criteria and to receive a request for a package to be delivered to the recipient, wherein the package has one or more package characteristics, and wherein the recipient has one or more recipient characteristics including at least one location characteristic and to analyze the advertisement selection criteria associated with an advertisement in conjunction with analyzing the package characteristics and recipient characteristics associated with the package and its recipient so as to select an advertisement for the package in response to the analyzing of the advertisement selection criteria, package characteristics, and recipient characteristics.

7. A parcel advertising system as recited in claim 1, wherein the selected advertisement is selected from among a plurality of available advertisements.

8. A parcel advertising system as recited in claim 1, wherein the selected advertisement is placed adjacent to postage on the package.

9. A parcel advertising system as recited in claim 1, wherein selected advertisement is placed adjacent to postage on a postage label that is affixed to the package.

10. A parcel advertising system as recited in claim 1, wherein the one or more location characteristics include a destination zip code for the package.

11. A parcel advertising system as recited in claim 1, wherein the one or more recipient characteristics include a gender of the recipient.

12. A parcel advertising system as recited in claim 1, wherein the one or more recipient characteristics include an age of the recipient.

13. A parcel advertising system as recited in claim 1, wherein the one or more package characteristics include contents of the package.

14. A parcel advertising system as recited in claim 1, wherein the one or more recipient characteristics include a buying history of the recipient.

15. A parcel advertising system as recited in claim 1, wherein the advertisement information is received for a plurality of advertisements, wherein each advertisement is stored in the datastore.

16. A parcel advertising system as recited in claim 1, wherein at least one package characteristic, recipient characteristic, or combination thereof is explicitly supplied from information provided with a package and a recipient from a said warehouse management system.

17. A parcel advertising system as recited in claim 1, wherein at least one package characteristic, recipient characteristic, or combination thereof is implicitly deduced from information explicitly provided with a package and a recipient.

18. A method for determining a targeted advertisement for a package, wherein the advertisement is specifically directed towards a recipient to whom to the package is being delivered, the method comprising:
receiving in an image server advertisement information including one or more advertisements that are desired to be placed, wherein the advertisement information is associated with advertisement selection criteria;
receiving in the image server a request for a package to be delivered to the recipient from a warehouse management system located remotely from the image server, wherein the package has one or more package characteristics, and wherein the recipient has one or more recipient characteristics including at least one location characteristic;
analyzing in the image server the advertisement selection criteria associated with an advertisement in conjunction with analyzing the package characteristics and recipient characteristics associated with the package and its recipient to determine a relevancy ranking for the advertisements so as to select an advertisement for the package for delivery to the recipient; and
sending from the image server to a said warehouse management system the selected advertisement such that the warehouse management system my place said selected advertisement on the package for delivery to the recipient.

19. The method of claim 18, wherein the selection of an advertisement for the package includes selecting an advertisement from a plurality of available advertisements.

20. The method of claim 18, wherein the receiving of advertisement information including one or more advertisements comprises: receiving advertisement information including a plurality of advertisements, wherein each advertisement is stored in the datastore.
